(19) United States
(12) Patent Application Publication
(10) Pub. No.: US 2026/0154671 A1
(43) Pub. Date: Jun. 4, 2026

(54) METHOD OF CODE SCANNING PAYMENT, ELECTRONIC DEVICE AND STORAGE MEDIUM

(71) Applicant: Beijing Zitiao Network Technology Co., Ltd., Beijing (CN)

(72) Inventors: Hao YUAN, Beijing (CN); Jiyun HAN, Beijing (CN); Qihang YANG, Beijing (CN); Dongxu ZHANG, Beijing (CN)

(21) Appl. No.: 19/346,362

(22) Filed: Sep. 30, 2025

(30) Foreign Application Priority Data
Dec. 2, 2024 (CN) 202411756897.0

(51) Int. Cl. G06Q 20/32; G06Q 20/40

(52) U.S. Cl. CPC G06Q 20/3274; G06Q 20/407

(57) ABSTRACT

A method of code scanning payment, an electronic device and a storage medium are provided. The method includes recording, when a payment code is generated for a client, a first payment state of the payment code in the client, obtaining a second payment state of the payment code from a server, determining, for each payment code recorded by the client, the payment code as a first payment code with a changed payment state when the second payment state of the payment code changes relative to the first payment state, and updating the first payment state corresponding to the first payment code to the second payment state; determining a first interactive action according to the second payment state of the first payment code; and executing the first interactive action.

### CROSS-REFERENCE TO RELATED APPLICATION

The present disclosure claims priority of the Chinese Patent Application No. 202411756897.0 filed on Dec. 2, 2024, the disclosure of which is incorporated herein by reference in its entirety as part of the present application.

### TECHNICAL FIELD

The present disclosure relates to a method of code scanning payment, a storage medium and an electronic device.

### BACKGROUND

With the continuous development of payment technology, code scanning payment has been widely used in various fields. The code scanning payment includes a scanned payment mode, and the scanned payment mode is a payment mode in which the user's client displays a payment code and the merchant scans the payment code to realize payment.

If the payment code displayed by the client for the first time is scanned by the merchant, the payment code will be in a payment process. If the payment waiting time is too long and the client does not perceive that the payment code displayed for the first time is in the payment process, the client will periodically refresh the payment code to a new payment code.

At this time, the client will no longer perceive the payment state of the payment code displayed for the first time. If the first code scanning payment requires an interactive action, such as identity verification or the like, before the payment can be successful, the client will not be able to perform the interactive action, resulting in payment failure.

### SUMMARY

The Summary is to introduce a selection of concepts in a simplified form that are further described below in the Detailed Description. The Summary is neither intended to identify key features or essential features of the claimed subject matter, nor is it intended to be used to limit the scope of the claimed subject matter.

The present disclosure provides a method of code scanning payment, including,
recording, when a payment code is generated for a client generates, a first payment state of the payment code in the client;
obtaining a second payment state of the payment code from a server;
determining, for each payment code recorded by the client, the payment code as a first payment code with a changed payment state when the second payment state of the payment code changes relative to the first payment state, and updating the first payment state corresponding to the first payment code to the second payment state;
determining a first interactive action according to the second payment state of the first payment code; and
executing the first interactive action.

The present disclosure provides a non-transitory computer-readable medium, on which a computer program is stored, where the computer program, when executed by a processing apparatus, implements steps of the method according to the above embodiments.

The present disclosure provides an electronic device, including:
a storage apparatus, on which a computer program is stored;
a processing apparatus, configured to execute the computer program on the storage apparatus, so as to implements steps of the method according to the above embodiment.

The present disclosure provides a computer program product, including a computer program, where the computer program, when executed by a processor, implements steps of the method according to the above embodiment.

### BRIEF DESCRIPTION OF DRAWINGS

The above and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale. In the accompanying drawings.

FIG. 1 is a flowchart of a method of code scanning payment according to some embodiments;

FIG. 2 is a flowchart of a method of code scanning payment according to some other embodiments;

FIG. 3 is a schematic structural diagram of an apparatus of code scanning payment according to some embodiments; and

FIG. 4 is a schematic structural diagram of an electronic device according to some embodiments.

### DETAILED DESCRIPTION

Embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this regard.

The terms “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. The relevant definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only and are not used to limit the scope of these messages or information.

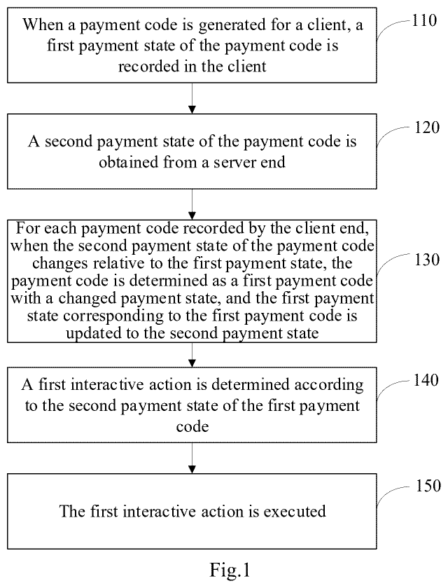

FIG. 1 is a flowchart of a method of code scanning payment according to some embodiments. As shown in FIG. 1, an embodiment of the present disclosure provides a method of code scanning payment. This method can be executed by a server, specifically by a code scanning payment apparatus. This apparatus can be implemented by means of software and/or hardware. As shown in FIG. 1, this method can include the following steps.

In step 110, when a payment code is generated for a client, a first payment state of the payment code is recorded in the client.

Here, the payment code is a QR code or bar code used for electronic payment, and the payment code contains information required for payment, such as payment amount, payee identification information, etc. When performing code scanning payment, the user shows a payment code, and the merchant or a payment terminal scan the payment code to complete the transaction.

In a payment cycle, every time a payment code is generated for the client, the first payment state of the payment code is recorded in the client. One payment cycle can refer to the period from the client displaying a payment code to the client exiting display of the payment code. That is, in the process of the client displaying a payment code, provided that a payment code is refreshed and displayed, the first payment state of this payment code can be recorded in the client. When the client exits display of the payment code, the client will delete all recorded payment codes.

A polling manager can be configured in the client, and the polling manager is configured to store the first payment states of the payment codes and to manage the stored payment codes. Every time the client generates a new payment code, the code value of the payment code is taken as the Key, and the first payment state of the payment code is taken as the Value, and the first payment state of the payment code is stored in the polling manager.

It should be noted that, in the embodiment of the present disclosure, the first payment state refers to a payment state of the payment code recorded in the client, and the first payment state can be different payment states in different situations.

In the embodiment of the present disclosure, the payment state of the payment code can include an initial state, an in-process state, an in-payment state, a pull checkout counter state, a pull payment success result page state and an order cancellation state. The initial state indicates a state when the payment code has not been scanned by the merchant or the payment terminal; the in-process state indicates that the server starts two-stage decoding on the payment code; the in-payment state indicates that the server creates a payment order for the payment code; the pull checkout counter state indicates notifying the client to display a checkout counter, so as to perform payment verification through the checkout counter; the pull payment success result page state indicates notifying the client to display a result page which represents that the payment order corresponding to the payment code has been successfully paid; the order cancellation state indicates that the transaction corresponding to the payment code has been cancelled. It should be noted that the order cancellation state of the payment code means that the server cancels the payment order of the payment code, thus canceling the transaction corresponding to the payment code.

In step 120, a second payment state of the payment code is obtained from a server.

Here, after the payment terminal scans the payment code, the server will perform a series of operations to process the payment request to complete the transaction. For example, the server can perform operations such as verifying the payment request, generating the payment order, conducting risk detection on the payment order, deducting the corresponding amount from the account after the risk detection is passed, sending a payment result notification, canceling the payment order, and so on. When the server performs a specific operation on the payment order corresponding to the payment code, the payment state of the payment code will also change accordingly.

It is worth noting that the second payment state refers to a payment state of the payment code obtained by the client from the server, which is different from the first payment state of the payment code stored in the client. For example, the first payment state of the payment code A stored in the client may be the initial state, while the second payment state of the payment code A in the server may be the in-process state.

The client obtaining the second payment state of the payment code from the server can be that the client actively pulls the second payment state of the payment code from the server, or that the client passively receives the second payment state of the payment code from the server.

Illustratively, the client receives the second payment state of the payment code pushed by the server through a long connection with the server.

It should be understood that after the client receives the second payment state of the payment code, the polling manager of the client will judge whether the received payment code is recorded in the polling manager of the client; if this payment code is not recorded in the polling manager of the client, this payment code will be discarded; and if this payment code is recorded in the polling manager of the client, the subsequent steps will continue to be performed. It should be noted that if this payment code is not recorded in the polling manager, it means that this payment code is not a payment code of the current payment cycle, but an expired payment code, and this payment code needs to be discarded.

Illustratively, the client can actively query the second payment state of the payment code from the server based on the code value of the payment code recorded by the polling manager.

In step 130, for each payment code recorded by the client, when the second payment state of the payment code changes relative to the first payment state, the payment code is determined as a first payment code with a changed payment state, and the first payment state corresponding to the first payment code is updated to the second payment state.

Here, in a payment cycle, the client may record one or more payment codes, and therefore, the second payment state of the payment code obtained from the server can be the second payment state of one or more payment codes.

For each payment code recorded by each polling manager, the polling manager compares the obtained second payment state of the payment code with the recorded first payment state of the payment code, so as to judge whether the payment state of the payment code is changed.

When the second payment state of the payment code changes relative to the first payment state, the polling manager can determine the payment code as the first payment code with a changed payment state, and update the first payment state corresponding to the first payment code to the second payment state.

For example, the first payment state of the payment code A recorded in the polling manager is the initial state, and the second payment state of the payment code A obtained from the server is the in-process state, then the payment code A is determined as the first payment code with a changed payment state. At the same time, the polling manager updates the recorded payment state of the payment code A from the initial state to the in-process state.

For another example, the first payment state of the payment code B recorded in the polling manager is the initial state, and the second payment state of the payment code B obtained from the server is the initial state, then the payment code B will not be determined as the first payment code with a changed payment state, and the payment state of the payment code B stored in the polling manager remains as the initial state.

It is worth noting that in the embodiment of the present disclosure, the first payment code refers to a type of payment code which is determined by comparing the first payment state and the second payment state to represent that the payment state is changed. In a polling process, the count of the determined first payment codes can be one or more. Moreover, the first payment state of the first payment code is updated to the second payment state, and after the second payment state of the payment code is obtained next time, the above steps can still be used to determine whether the payment state of the payment code is changed.

In step 140, a first interactive action is determined according to the second payment state of the first payment code.

Here, the payment state of the first payment code is changed, that is, the payment code changes from the first payment state to the second payment state, so the first interactive action to be output by the client can be determined according to the second payment state of the first payment code. Illustratively, different payment states can correspond to different interactive actions. For example, the interactive action corresponding to the pull checkout counter state is to display a checkout counter. The interactive action corresponding to the pull payment success result page state is to display a result page which represents that the payment order corresponding to the payment code has been successfully paid.

In some embodiments, if the count of the first payment codes is multiple, the first interactive action can be determined according to the second payment state with the highest priority among the second payment states of the multiple first payment codes.

In the embodiment of the present disclosure, the priority of the payment state is: the pull payment success result page state>the pull checkout counter state>the order cancellation state>the in-process state>the initial state. If the second payment state of the first payment code A is the in-process state, the second payment state of the first payment code B is the pull checkout counter state, and the second payment state of the first payment code C is the pull payment success result page state, then the first interactive action is determined according to the second payment state of the first payment code C.

It should be noted that, the first interactive action is determined according to the second payment state with the highest priority among the second payment states of multiple first payment codes, which actually integrates the multi-dimensional payment states into one-dimensional interactive action to be presented to the user.

It is worth noting that, in the embodiment of the present disclosure, the interactive action can be the action of displaying a specific page in a foreground interface, to display the corresponding payment information and interactive behavior to the user.

In the embodiment of the present disclosure, when the polling manager determines that the payment state of any payment code is changed, it can send a payment state updating event to a payment state processor, and the payment state updating event includes the first payment code and the second payment state corresponding to the first payment code. In response to the payment state updating event, the payment state processor determines the first interactive action according to the second payment state with the highest priority among the second payment states of the first payment codes in the payment state updating events. The payment state updating event for the second payment state with a relatively lower priority will be discarded, so that the user can always see the most important information and interactive action.

In step 150, the first interactive action is executed.

Here, after the client determines the first interactive action, the client executes the first interactive action, to display the corresponding page. For example, if the second payment state of the payment code is the pull checkout counter state and the determined first interactive action is to display the checkout counter, the client executes the first interactive action to display the checkout counter.

Therefore, when the client generates a payment code, a first payment state of the payment code is recorded in the client, and a second payment state of the payment code is obtained from the server. For each payment code recorded by the client, when the second payment state of the payment code changes relative to the first payment state, the payment code is determined as a first payment code with a changed payment state, and the first payment state corresponding to the first payment code is updated to the second payment state. Then, according to the second payment state of the first payment code, a first interactive action is determined, and the first interactive action is executed, so that the client can perceive the change of the payment state of the payment code displayed before the currently displayed payment code, thereby supporting multiple payment codes to be scanned and ensuring that the user can use the payment code to perform code scanning payment under any circumstances.

In some scenarios, a first piece of payment code generated by the client is scanned by a payment terminal, and the first piece of payment code is in the payment process. If the waiting time is too long and the client does not perceive that the first piece of payment code is in the payment process, the client will periodically refresh and display a second piece of payment code. At this time, in the related art, the client will no longer perceive the payment state of the first piece of payment code; and if the payment order corresponding to the first piece of payment code needs to display the checkout counter for identity verification before deduction, the client will not be able to respond to the operation of displaying the checkout counter, resulting in payment failure. According to the method of code scanning payment provided by the embodiment of the present disclosure, the client can perceive the changes of the payment states of the first piece of payment code and the second piece of payment code, and perform corresponding interactive actions, so that the user can still use the payment code to pay normally in extreme cases, and the user experience of using code scanning payment is greatly guaranteed.

In some feasible implementations, in step 130, when the second payment state of the payment code changes relative to the first payment state, if the second payment state of the payment code is not the order cancellation state which represents that the transaction corresponding to the payment code is cancelled, the payment code is determined as the first payment code, and the first payment state of the first payment code is updated to the second payment state.

Here, the polling manager can compare the priority of the second payment state of the payment code with the priority of the first payment state of the payment code, and determine that the payment state of the payment code is changed when the priority of the second payment state is higher than the priority of the first payment state of the payment code. Further, the polling manager determines whether the second payment state of the payment code is the order cancellation state which represents that the transaction corresponding to the payment code is cancelled, and determines the payment code as the first payment code if the second payment state of the payment code is not the order cancellation state.

It should be noted that if the second payment state of the payment code obtained from the server is the order cancellation state, it means that the payment order corresponding to the payment code has been cancelled; if the second payment state of the payment code obtained from the server is not the order cancellation state, it means that the payment order corresponding to the payment code is still being processed.

When the second payment state corresponding to the payment code of which second payment state changes relative to the first payment state is not the order cancellation state, the payment code is determined as the first payment code, and the first payment state, stored in the polling manager, of the first payment code is updated to the second payment state.

It is worth noting that when the priority of the second payment state is lower than or equal to the priority of the first payment state of the payment code, it is determined that the payment state of the payment code is not changed, then the payment code can be left unprocessed, and the polling manager continues to poll the next payment code.

Therefore, according to the above implementation, the client may not respond to the interactive action of the payment code in the order cancellation state, to ensure the smooth progress of the code scanning payment.

In some feasible implementations, if the second payment state of the payment code is the order cancellation state, the payment code is deleted from the record of the client, a second payment code is determined from the payment codes recorded by the client, and the second payment code is a payment code with a highest priority corresponding to the first payment state recorded by the client. Accordingly, step 150 can be to determine the first interactive action according to the second payment state of the first payment code and the first payment state of the second payment code.

Here, the polling manager can compare the priority of the second payment state of the payment code with the priority of the first payment state of the payment code, and determine that the payment state of the payment code is changed when the priority of the second payment state is higher than the priority of the first payment state of the payment code. Further, the polling manager determines whether the second payment state of the payment code is the order cancellation state which represents that the transaction corresponding to the payment code is cancelled; and if the second payment state of the payment code is the order cancellation state, it means that the payment order corresponding to the payment code has been cancelled and the life cycle of the payment code has ended.

At this time, the payment code in the order cancellation state can be deleted from the record of the polling manager, and the payment state of the payment code in the order cancellation state will no longer be perceived in the future. Moreover, because the client may continue to show the interactive action of the payment code in the order cancellation state, in order to prevent the client from continuing to show the interactive action of the payment code in the order cancellation state, a second payment code can be determined from the payment codes recorded in the polling manager of the client, so as to refresh the interactive action of the client through the first payment state of the second payment code.

The second payment code is a payment code with a highest priority corresponding to the first payment state recorded by the client. It is worth noting that the second payment code determined from the polling manager will not be a payment code in the order cancellation state because the payment code in the order cancellation state has been deleted from the polling manager.

Illustratively, if the second payment state of the payment code is the order cancellation state, the polling manager deletes the payment code in the order cancellation state from the record of the client, determines a second payment code from the payment codes recorded by the polling manager, and then generates an end event based on the first payment state of the second payment code, and transmits the end event to a payment state processor; the payment state processor, in response to receiving the end event, determines the first interactive action according to the first payment state of the second payment code in the end event and the second payment state of the first payment code in the payment state updating event.

It should be understood that if the payment state processor does not receive the payment state updating event, the first interactive action can be determined according to the first payment state of the second payment code in the end event.

In some embodiments, the payment state with the highest priority from the second payment state of the first payment code and the first payment state of the second payment code can be determined as a third payment state, and then the first interactive action can be determined according to the third payment state.

In some embodiments, in response to the third payment state being the second payment state of the first payment code, in response to the priority corresponding to the third payment state being higher than or equal to the priority of a payment state corresponding to an interactive action being executed by the client, the first interactive action is determined according to the third payment state; in response to the third payment state being the first payment state of the second payment code, the first interactive action is determined according to the third payment state.

If the third payment state is the second payment state of the first payment code, the priority of the second payment state is compared with the priority of the payment state corresponding to the interactive action being executed by the client; and when the priority of the second payment state is higher than or equal to the priority of the payment state corresponding to the interactive action being executed by the client, the first interactive action is determined according to the second payment state. If the determined third payment state is the first payment state of the second payment code, the first interactive action of the first payment state is directly executed.

It is worth noting that if the determined third payment state is the first payment state of the second payment code, since the priority corresponding to the interactive action currently executed by the client may be higher than the priority of the first payment state of the second payment code, and the payment code corresponding to the interactive action currently executed by the client may be in the order cancellation state, in order to refresh the interactive action of the client, when the determined third payment state is the first payment state of the second payment code, the first interactive action corresponding to the first payment state of the second payment code can be directly executed, so as to ensure that the client can display the interactive action of the payment code that is not in the order cancellation state.

Therefore, according to the above implementation, a corresponding interactive action can be determined according to the different payment states of the payment codes, thus ensuring the smooth progress of code scanning payment.

In some feasible implementations, a new payment code is displayed in response to the payment code currently displayed by the client being a payment code in the order cancellation state.

Here, the polling manager can compare the priority of the second payment state of the payment code with the priority of the first payment state of the payment code, and determine that the payment state of the payment code is changed when the priority of the second payment state is higher than the priority of the first payment state of the payment code. Further, the polling manager determines whether the second payment state of the payment code is the order cancellation state which represents that the transaction corresponding to the payment code is cancelled; and if the second payment state of the payment code is the order cancellation state, the payment code in the order cancellation state can be deleted from the record of the polling manager, and the payment state of the payment code in the order cancellation state will no longer be perceived in the future. Moreover, because the client may continue to show the interactive action of the payment code in the order cancellation state, in order to prevent the client from continuing to show the interactive action of the payment code in the order cancellation state, a second payment code can be determined from the payment codes recorded in the polling manager of the client. Moreover, the polling manager can further judge whether the payment code currently displayed by the client is a payment code in the order cancellation state, and if the payment code currently displayed by the client is a payment code in the order cancellation state, the client displays a new payment code.

It should be understood that if the payment code currently displayed by the client is a payment code in the order cancellation state, because the payment code is in the order cancellation state, which means that the life cycle of the payment code has ended, it is meaningless to continue displaying the payment code, and the client can display a new payment code.

It is worth noting that the first payment state corresponding to the displayed new payment code will also be recorded in the polling manager, to continue to perceive the payment state of the new payment code in the subsequent process.

Therefore, according to the above implementation, when the payment state of the payment code currently displayed by the client is perceived to be the order cancellation state, it can refresh and display a new payment code, so as to ensure the smooth progress of code scanning payment.

In some feasible implementations, in response to the first payment code being a payment code currently displayed by the client and the second payment state of the first payment code representing that the first payment code has entered a payment processing flow, the periodic display of new payment codes is stopped.

Here, the polling manager can compare the priority of the second payment state of the payment code with the priority of the first payment state of the payment code, and determine that the payment state of the payment code is changed when the priority of the second payment state is higher than the priority of the first payment state of the payment code, and then the payment code is a first payment code. Further, the polling manager judges whether the first payment code is the payment code currently displayed by the client; if the first payment code is the payment code currently displayed by the client and the second payment state of the first payment code represents that the first payment code has entered a payment processing flow, the client is controlled to stop the periodic display of new payment codes.

The second payment state of the first payment code represents that the first payment code has entered the payment processing flow, meaning that the second payment state of the first payment code is in a state other than the initial state, and indicating that the first payment code has generated a payment order and has entered the in-process procedure. For example, the second payment state of the first payment code is the pull payment success result page state, the pull checkout counter state, the order cancellation state, the in-process state or the like.

In response to the first payment code being the payment code currently displayed by the client and the second payment state of the first payment code representing that the first payment code has entered the payment processing flow, the payment code currently displayed by the client is actually in the payment processing flow, and there is no need to display a new payment code; therefore, the client can be controlled to stop the periodical display of new payment codes, so as to avoid generating multiple payment orders.

Therefore, according to the above implementation, it can avoid generating multiple payment orders, thus ensuring the orderly progress of code scanning payment and avoiding repeated payments.

In some feasible implementations, in step 130, whether the payment code meets a first preset condition can be determined according to the second payment state of the payment code and the first payment state of the payment code; in response to the payment code not meeting the first preset condition, if the second payment state of the payment code changes relative to the first payment state, the payment code can be determined as the first payment code with the changed payment state, and the first payment state corresponding to the first payment code can be updated to the second payment state.

Here, after the polling manager obtains the second payment state of the payment code from the server, for each payment code, the polling manager judges whether the payment code meets the first preset condition according to the second payment state of the payment code and the first payment state of the payment code; in response to the payment code not meeting the first preset condition, the second payment state of the payment code is compared with the first payment state, and if the second payment state of the payment code changes relative to the first payment state, the payment code is determined as the first payment code with the changed payment state, and the first payment state corresponding to the first payment code is updated to the second payment state.

The first preset condition is that the first payment state and the second payment state represent that the payment code has entered a payment processing flow, and the payment code has not been updated from the payment processing flow to a flow of displaying a payment result page within a first preset duration.

Being updated from the payment processing flow to the flow of displaying the payment result page indicates that the payment code has entered the final payment state and is at the end of its life cycle. If the payment code is not updated from the payment processing flow to the flow of displaying the payment result page within the first preset duration, it means that the payment code has encountered a payment timeout error.

For example, if the first payment state of a payment code is in the in-process state (indicating that the payment code has entered the payment processing flow), due to the lack of network or weak network environment, there may be problems with the payment of the payment code. If the second payment state of the payment code does not enter any of the payment states including the pull payment success result page state, the pull checkout counter state and the order cancellation state within 60 seconds (the first preset duration), it indicates that the payment code has encountered a payment timeout error. Therefore, the payment code that meets the first preset condition can actually be understood as a payment code that has encountered a payment timeout error.

That is, judging whether the payment code meets the first preset condition according to the second payment state of the payment code and the first payment state of the payment code can actually be understood as judging whether the payment code has encountered a payment timeout error; if the payment timeout error occurs, the payment code does not need to be judged whether the payment state changes.

When the payment code does not meet the first preset condition, it means that the payment code does not encounter a payment timeout error, and the polling manager further judges whether the second payment state of the payment code changes relative to the first payment state of the payment code.

In some feasible implementations, in response to the payment code meeting the first preset condition, the payment code is determined as a third payment code. Accordingly, in step 140, the first interactive action is determined according to the second payment state of the first payment code and the fourth payment state of the third payment code.

It is worth noting that the third payment code refers to a type of payment code which is determined through the first preset condition to represent the occurrence of the payment timeout error. In a polling process, the count of the determined third payment codes can be one or more.

For the payment code that meets the first preset condition, the polling manager determines the payment code as the third payment code and assigns a fourth payment state to the third payment code.

The fourth payment state is a payment state corresponding to the first preset condition, and the interactive action corresponding to the fourth payment state is to display a default result page.

It should be noted that the fourth payment state is not a payment state of the payment code obtained from the server, but a payment state allocated by the client for the payment code meeting the first preset condition. For example, the fourth payment state can be a default result page state, and the interactive action corresponding to the fourth payment state can be to display a default result page, so as to inform the user that there is an error in the payment of the payment code through the default result page, thus prompting the user to check whether the payment order of the payment code has been paid successfully.

The payment state processor determines the first interactive action according to the second payment state of the first payment code and the fourth payment state of the third payment code.

Illustratively, the payment state processor can determine the first interactive action according to the payment state with the highest priority from the second payment state of the first payment code and the fourth payment state of the third payment code.

In the embodiment of the disclosure, the priority of payment state is: the pull payment success result page state=the default result page state>the pull checkout counter state>the order cancellation state>the in-process state>the initial state.

It is worth noting that if there is no payment state updating event at this time, the first interactive action can be determined according to the fourth payment state of the third payment code. Of course, if there is an end event at this time, the payment state processor can determine the first interactive action according to the payment state with the highest priority among the second payment state of the first payment code, the fourth payment state of the third payment code and the first payment state of the second payment code, so that the user can always see the most important information and interactive action.

Therefore, according to the above implementation, the client can perceive the payment code meeting the first preset condition, and display the corresponding first interactive action, so that the user can know the occurrence of the payment order with payment timeout error.

In some feasible implementations, the client can further delete the payment code of which first payment state meets a second preset condition from the record of the client, where the second preset condition includes that the first payment state of the payment code represents that the payment code enters a process of displaying a payment result page, or the second preset condition includes that the first payment state of the payment code is the initial state and the payment code remains in the initial state for a second preset duration.

Here, the payment code enters a process of displaying a payment result page, which represents that the payment code has entered the final payment state and is at the end of its life cycle. For example, when the first payment state is changed to any of the payment states including the pull payment success result page state, the pull checkout counter state and the order cancellation state, it means that the payment code has entered the process of displaying the payment result page.

Because the payment code has entered the final payment state and the final payment result (payment success/payment failure) can be determined by the payment code, the payment state of the payment code does not need to be continuously perceived. Therefore, the payment code of which first payment state meets the second preset condition can be deleted from the payment codes recorded by the polling manager.

The first payment state is the initial state and the payment code retains in the initial state for a second preset duration, which means that the payment state of the payment code has been the initial state for the second preset duration; then the payment code has timed out and the client does not need to continue to perceive the payment state of the payment code.

For example, when the first payment state of the payment code is the initial state, if the second payment state obtained from the server indicates that the payment state of the payment code has been in the initial state within 120 seconds (the second preset duration) and it has not entered a payment state with a priority higher than or equal to the priority of the in-process state, then the payment code meets the second preset condition.

In response to any payment code meeting the second preset condition, the polling manager deletes the payment code of which first payment state meets the second preset condition from the record of the polling manager, and then no longer perceives the change of the payment state of the payment code in the future.

Therefore, according to the above implementation, the client may not perceive the payment state of the payment code that has timed out or the payment state of the payment code that has reached the final state, which can not only reduce the calculation amount of the client, but also ensure the smooth progress of code scanning payment of the payment code.

In some feasible implementations, in step 150, in response to the first interactive action being to display a checkout counter, the first interactive action is discarded if the client is displaying the checkout counter, and the first interactive action is executed if the client is not displaying the checkout counter; in response to the first interactive action being to display a payment result page, the first interactive action is discarded if the client is displaying the checkout counter, and the first interactive action is executed if the client is not displaying the checkout counter.

Here, when the determined first interactive action is to display the checkout counter, it is detected whether the client is currently displaying the checkout counter. If the client is currently displaying the checkout counter, the first interactive action is discarded, and the first interactive action is no longer executed. If the client is not currently displaying the checkout counter, the client executes the first interactive action and displays the checkout counter.

In some embodiments, when the checkout counter is displayed, in response to a successful payment operation for the checkout counter, the display of the payment code is exited, and the payment code recorded by the client is deleted.

The successful payment operation for the checkout counter can mean that the user completes the payment verification through the displayed checkout counter, so that the payment order corresponding to the payment code can be completed.

In this case, the code scanning payment of the payment code is completed within a payment cycle, and the client can exit the user interface displaying the payment code and delete the payment code recorded in the polling manager.

When the determined first interactive action is to display a payment result page, it is detected whether the client is currently displaying the checkout counter. If the client is currently displaying the checkout counter, since the first interactive action of displaying the payment result page is discarded, first interactive action is no longer executed. If the client is not currently displaying the checkout counter, the client executes the first interactive action and displays the payment result page.

It should be noted that the payment result page can be the default result page corresponding to the default result page state or the payment success result page corresponding to the pull payment success result page state.

In some embodiments, when the payment result page is displayed, in response that display of the payment result page is ended, the display of the payment code can be exited, and the payment code recorded by the client can be deleted.

Display of the payment result page is ended, which means that the display duration of the payment result page reaches a preset duration, or a trigger operation to exit display of the payment result page is detected.

In this case, the code scanning payment of the payment code is completed within a payment cycle, and the client can exit the user interface displaying the payment code and delete the payment code recorded in the polling manager.

It should be understood that if the first interactive action is not to display the checkout or not to display the payment result page, the first interactive action is displayed through a preset interactive display logic, which is not specifically limited in the embodiment of the present disclosure.

Therefore, according to the above implementation, the orderly execution of the interactive actions can be ensured, to ensure that user can always see the most important payment information and interactive action.

In some feasible implementations, when the first interactive action is to display a checkout counter, in step 150, the checkout counter can be displayed; and the payment code corresponding to the first interactive action is deleted from the record of the client in response to a payment cancellation operation for the checkout counter; and then a first payment state with the highest priority is selected from the payment codes recorded by the client, and a new first interactive action is determined according to the selected first payment state, and the new first interactive action is executed.

Here, when the checkout counter is displayed, if a successful payment operation for the checkout counter is detected, the display of the payment code is exited and the payment code recorded by the client is deleted. If a payment cancellation operation for the checkout counter is detected, the payment code corresponding to the first interactive action is deleted from the record of the client.

The payment cancellation operation for the checkout counter can be an operation triggered by the user in the displayed checkout counter to indicate payment cancellation. For example, the payment cancellation operation can be to exit the display of the checkout counter.

It should be noted that when the payment cancellation operation for the checkout counter is detected, it means that the payment order of the corresponding payment code has been cancelled by the user, and the payment state of the payment code subsequently perceived has become invalid, so the payment code corresponding to the first interactive action can be deleted from the record of the polling manager, and the change of the payment state of the payment code will no longer be perceived in the future. Moreover, the payment order of the payment code has been cancelled by the user, and the client needs to continue to display the interactive actions of other payment codes, so the client can select the first payment state with the highest priority from the payment codes recorded by the client, determine a new first interactive action according to the selected first payment state, and then execute the new first interactive action. It is worth noting that because the payment code corresponding to the payment cancellation operation has been deleted from the record of the polling manager, the first payment state with the highest priority selected from the polling manager will not be a payment state of a payment code corresponding to the payment cancellation operation.

It should be understood that the first payment state with the highest priority can be selected from the payment codes recorded by the client and a new first interactive action is determined according to the selected first payment state, and the interactive action executed by the client can be refreshed through the new first interactive action. Moreover, because the selected first payment state is the first payment state with the highest priority, it can also ensure that the most important information and interactive action are displayed to the user.

In some embodiments, in response to a payment cancellation operation for the checkout counter, the payment code corresponding to the first interactive action is deleted from the record of the client, and a new payment code is displayed in response to the payment code corresponding to the first interactive action being the payment code currently displayed by the client.

If the payment code currently displayed by the client is a payment code corresponding to the payment cancellation operation, it is meaningless to continue displaying the payment code because the payment order of the payment code has been cancelled by the user; and therefore, the client can display a new payment code.

It should be noted that the first payment state corresponding to the displayed new payment code will also be recorded in the polling manager, to continue to perceive the payment state of the new payment code in the subsequent process.

In the embodiment of the present disclosure, the operation for the payment code in the order cancellation state and the operation for the payment code corresponding to the payment cancellation operation are actually the same, that is, the corresponding payment code is deleted from the record of the client, a new payment code is displayed in response to the corresponding payment code being a payment code currently displayed by the client, a first payment state with the highest priority is selected from the payment codes recorded by the client, and a new first interactive action is determined according to the selected first payment state.

Therefore, according to the above implementation, after the payment order corresponding to the payment code is cancelled by the user, the client can still display other more important interactive actions and refresh and display new payment codes, to ensure the smooth progress of code scanning payment.

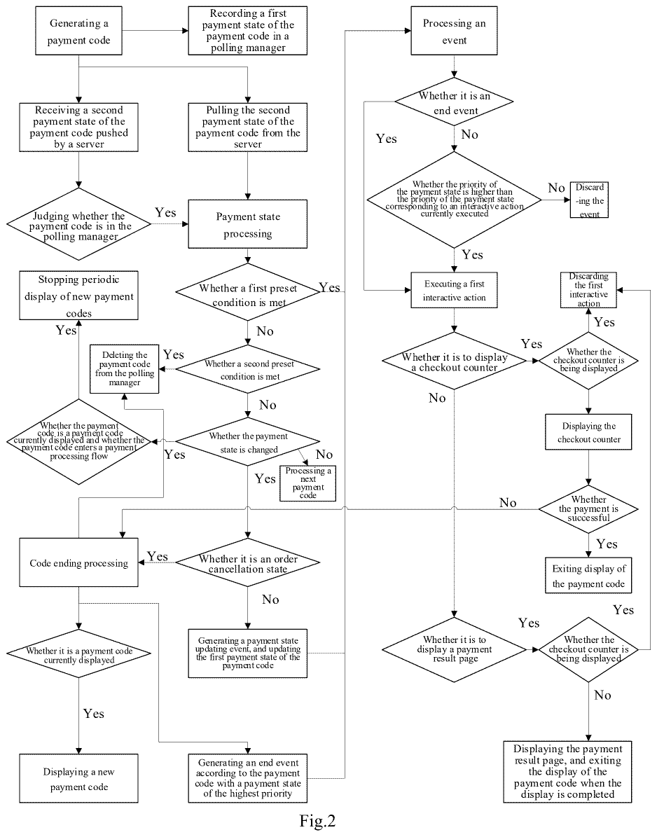

FIG. 2 is a flowchart of a method of code scanning payment according to some other embodiments. As shown in FIG. 2, the method of code scanning payment can include the following steps.

When a payment code is generated, a first payment state of the payment code is recorded in a polling manager. Subsequently, the client receives a second payment state of the payment code pushed by a server, and judges whether the payment code is in the polling manager, and performs payment state processing on the payment code if it is in the polling manager. Moreover, the client pulls the second payment state of the payment code from the server, and performs payment state processing on the pulled payment code.

The payment state processing can include the following steps:

For each payment code, the polling manager judges whether the payment code meets a first preset condition according to the second payment state of the payment code and the first payment state of the payment code; and in response to meeting the first preset condition, the polling manager determines the payment code as a third payment code, and informs a payment state processor to processing an event (determining a first interactive action according to a fourth payment state of the third payment code). If the first preset condition is not met, it is judged whether the payment code meets a second preset condition; if the second preset condition is met, the payment code is deleted from the polling manager; if the second preset condition is not met, it is judged whether the payment state is changed; if the payment state is not changed, the polling manager processes a next payment code. If the payment state is changed, it is judged whether the payment code with the changed payment state is a payment code currently displayed and whether the payment code enters a payment processing flow; if the payment code with the changed payment state is the currently displayed payment code and the payment code enters the payment processing flow, the periodic display of new payment codes is stopped. At the same time, if the payment state is changed, it is judged whether the second payment state of the payment code with the changed payment state is an order cancellation state; if it is the order cancellation state, code ending processing is executed; If it is not the order cancellation state, a payment state updating event is generated, and the first payment state of the payment code is updated. The code ending processing can include the following steps:

It is judged whether the payment code is a payment code currently displayed, and if it is, a new payment code is displayed. Moreover, the payment code is deleted from the polling manager. Furthermore, an end event is generated according to the payment code with a payment state of the highest priority, and the end event is sent to the payment state processor. The payment state processor executes the operation of processing an event, determines the payment state with the highest priority from all of the received payment codes, and determines a first interactive action according to the payment state with the highest priority. It is judged whether the payment state corresponding to the first interactive action is an end event; if it is, the first interactive action is directly executed; and if it is not, it is further judged whether the priority of the payment state of the first interactive action is higher than the priority of the payment state corresponding to an interactive action currently executed; if it is not, the event corresponding to the first interactive action is discarded; and if it is, the first interactive action is executed.

When the first interactive action is executed, it is judged whether the first interactive action is to display a checkout counter; if it is, it is judged whether the checkout counter is being displayed, if it is, the first interactive action is discarded, if it is not, the checkout counter is displayed. When the checkout counter is displayed, it is judged whether the payment is successful, if it is successful, the display of the payment code is exited, and if it is not successful, the code ending processing is executed.

If the first interactive action is not to display the checkout counter, it is judged whether the first interactive action is to display a payment result page, if it is, it is judged whether the checkout counter is being displayed, if it is, the first interactive action is discarded, if it is not, the payment result page is displayed, and the display of the payment code is exited when the display is completed.

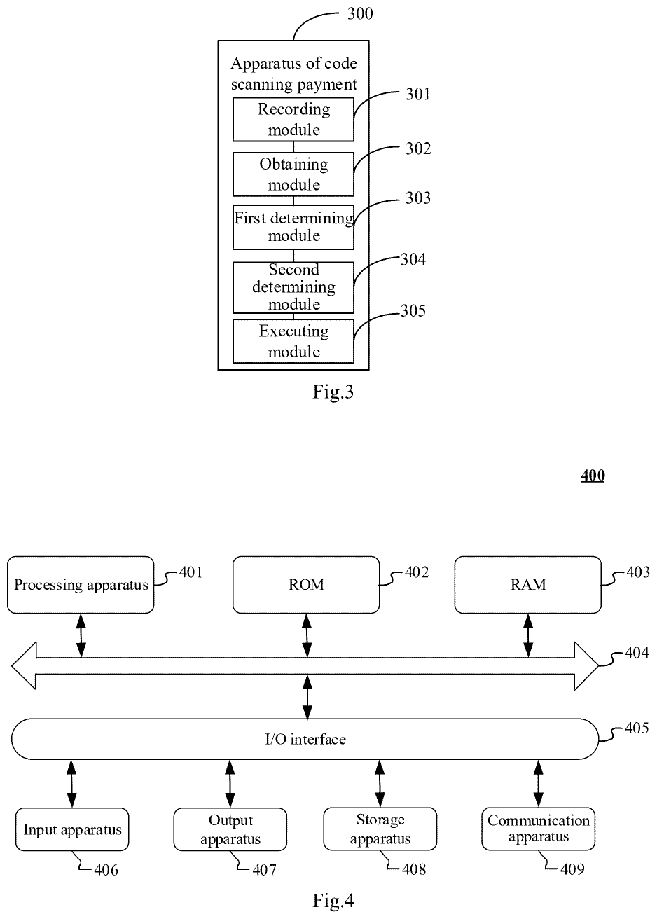

FIG. 3 is a schematic structural diagram of a code scanning payment apparatus according to some embodiments. As shown in FIG. 3, an embodiment of the present disclosure provides a code scanning payment apparatus 300, which can include:
a recording module 301, configured to record, when a payment code is generated for a client, a first payment state of the payment code in the client;
an obtaining module 302, configured to obtain a second payment state of the payment code from a server;
a first determining module 303, configured to determine, for each payment code recorded by the client, the payment code as a first payment code with a changed payment state when the second payment state of the payment code changes relative to the first payment state, and update the first payment state corresponding to the first payment code to the second payment state;
a second determining module 304, configured to determine a first interactive action according to the second payment state of the first payment code;
an executing module 305, configured to execute the first interactive action.

Optionally, the first determining module 303 is specifically configured to:
determine, when the second payment state of the payment code changes relative to the first payment state, the payment code as the first payment code if the second payment state of the payment code is not an order cancellation state representing that a transaction corresponding to the payment code is cancelled, and update the first payment state corresponding to the first payment code to the second payment state.

Optionally, the first determining module 303 is further configured to:
delete, if the second payment state of the payment code is the order cancellation state, the payment code from a record of the client, and determine a second payment code from payment codes recorded by the client, where the second payment code is a payment code with a highest priority corresponding to the first payment state recorded by the client;
and the second determining module 304 is specifically configured to:
determine the first interactive action according to the second payment state of the first payment code and the first payment state of the second payment code.

Optionally, the second determining module 304 is specifically configured to:
determine a payment state with the highest priority from the second payment state of the first payment code and the first payment state of the second payment code as a third payment state;
determine the first interactive action according to the third payment state.

Optionally, the second determining module 304 is specifically configured to:
determine, in response to the third payment state being the second payment state of the first payment code, the first interactive action according to the third payment state if a priority corresponding to the third payment state is higher than or equal to a priority of a payment state corresponding to an interactive action being executed by the client;
determine, in response to the third payment state being the first payment state of the second payment code, the first interactive action according to the third payment state.

Optionally, the code scanning payment apparatus 300 further includes:
a first display module, configured to display, in response to a payment code currently displayed by the client being a payment code in an order cancellation state, a new payment code.

Optionally, the code scanning payment apparatus 300 further includes:
a second display module, configured to stop, in response to the first payment code being a payment code currently displayed by the client and the second payment state of the first payment code representing that the first payment code has entered a payment processing flow, a periodical display of new payment codes.

Optionally, the first determining module 303 is specifically configured to:
determine whether the payment code meets a first preset condition according to the second payment state of the payment code and the first payment state of the payment code, where the first preset condition is that the first payment state and the second payment state represent that the payment code has entered a payment processing flow, and the payment code has not been updated from the payment processing flow to a flow of displaying a payment result page within a first preset duration;
determine, in response to the payment code does not meeting the first preset condition, the payment code as the first payment code with the changed payment state if the second payment state of the payment code changes relative to the first payment state, and update the first payment state corresponding to the first payment code to the second payment state.

Optionally, the first determining module 303 is further configured to:
determine, in a response to the payment code meeting the first preset condition, the payment code as a third payment code;
and the second determining module 304 is specifically configured to:
determine the first interactive action according to the second payment state of the first payment code and a fourth payment state of the third payment code, where the fourth payment state is a payment state corresponding to the first preset condition, and an interactive action corresponding to the fourth payment state is to display a default result page.

Optionally, the code scanning payment apparatus 300 further includes:
a deleting module, configured to delete the payment code of which first payment state meets a second preset condition from a record of the client, where the second preset condition includes that the first payment state of the payment code represents that the payment code enters a process of displaying a payment result page, or the second preset condition includes that the first payment state of the payment code is an initial state and the payment code remains in the initial state for a second preset duration.

Optionally, the executing module 305 is specifically configured to:
in response to the first interactive action being to display a checkout counter, discard the first interactive action if the client is displaying the checkout counter, and execute the first interactive action if the client is not displaying the checkout counter;
in response to the first interactive action being to display a payment result page, discard the first interactive action if the client is displaying the checkout counter, and execute the first interactive action if the client is not displaying the checkout counter.

Optionally, the executing module 305 is further configured to:
exit, in response to a successful payment operation for the checkout counter, display of the payment code, and delete the payment code recorded by the client; or
exit, in response that display of the payment result page is ended, display of the payment code, and delete the payment code recorded by the client.

Optionally, the first interactive action includes displaying a checkout counter, and the executing module 305 is specifically configured to:
display the checkout counter;
delete, in response to a payment cancellation operation for the checkout counter, the payment code corresponding to the first interactive action from a record of the client;
select a first payment state with a highest priority from the payment codes recorded by the client, and determine a new first interactive action according to the selected first payment state;
execute the new first interactive action.

Optionally, the executing module 305 is specifically configured to:
delete, in response to the payment cancellation operation for the checkout counter, the payment code corresponding to the first interactive action from the record of the client, and display a new payment code in response to the payment code corresponding to the first interactive action being a payment code currently displayed by the client.

The logic of the method executed by various functional modules in the above code scanning payment apparatus 300 can refer to the related part of the method according to the above embodiments, and details will not be repeated here.

Referring to FIG. 4, FIG. 4 illustrates a schematic structural diagram of an electronic device (for example, client) 400 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 4 is merely an example, and should not pose any limitation to the functions and the range of use of the embodiments of the present disclosure.

As illustrated in FIG. 4, the electronic device 400 may include a processing apparatus 401 (e.g., a central processing unit, a graphics processing unit, etc.), which can perform various suitable actions and processing according to a program stored in a read-only memory (ROM) 402 or a program loaded from a storage apparatus 408 into a random-access memory (RAM) 403. The RAM 403 further stores various programs and data required for operations of the electronic device 500. The processing apparatus 501, the ROM 402, and the RAM 403 are interconnected by means of a bus 504. An input/output (I/O) interface 405 is also connected to the bus 404.

Usually, the following apparatus may be connected to the I/O interface 405: an input apparatus 406 including, for example, a touch screen, a touch pad, a keyboard, a mouse, a camera, a microphone, an accelerometer, a gyroscope, or the like; an output apparatus 407 including, for example, a liquid crystal display (LCD), a loudspeaker, a vibrator, or the like; a storage apparatus 408 including, for example, a magnetic tape, a hard disk, or the like; and a communication apparatus 409. The communication apparatus 509 may allow the electronic device 400 to be in wireless or wired communication with other devices to exchange data. While FIG. 4 illustrates the electronic device 400 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 409 and installed, or may be installed from the storage apparatus 408, or may be installed from the ROM 402. When the computer program is executed by the processing apparatus 401, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The computer-readable medium carries one or more programs, and the one or more programs, when executed by an electronic device, cause the electronic device to: record, when a client generates a payment code, a first payment state of the payment code in the client; obtain a second payment state of the payment code from a server; determine, for each payment code recorded by the client, the payment code as a first payment code with a changed payment state when the second payment state of the payment code changes relative to the first payment state, and update the first payment state corresponding to the first payment code to the second payment state; determine a first interactive action according to the second payment state of the first payment code; execute the first interactive action.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims. Specific manners of operations performed by the modules in the apparatus in the above embodiment have been described in detail in the embodiments regarding the method, which will not be explained and described in detail herein again.

1. A method of code scanning payment, comprising:
recording, when a payment code is generated for a client, a first payment state of the payment code in the client;
obtaining a second payment state of the payment code from a server;
determining, for each payment code recorded by the client, the payment code as a first payment code with a changed payment state when the second payment state of the payment code changes relative to the first payment state, and updating the first payment state corresponding to the first payment code to the second payment state;
determining a first interactive action according to the second payment state of the first payment code; and
executing the first interactive action.

2. The method according to claim 1, wherein the determining, for each payment code recorded by the client, the payment code as a first payment code with a changed payment state when the second payment state of the payment code changes relative to the first payment state, and updating the first payment state corresponding to the first payment code to the second payment state, comprises:
determining, when the second payment state of the payment code changes relative to the first payment state, the payment code as the first payment code, in response to the second payment state of the payment code being not an order cancellation state indicating that a transaction corresponding to the payment code is cancelled, and updating the first payment state corresponding to the first payment code to the second payment state.

3. The method according to claim 2, further comprising:
deleting, in response to the second payment state of the payment code being the order cancellation state, the payment code from a record of the client, and determining a second payment code from payment codes recorded by the client, wherein the second payment code is a payment code with a highest priority corresponding to the first payment state recorded by the client;
the determining a first interactive action according to the second payment state of the first payment code comprises:
determining the first interactive action according to the second payment state of the first payment code and the first payment state of the second payment code.

4. The method according to claim 3, wherein the determining the first interactive action according to the second payment state of the first payment code and the first payment state of the second payment code comprises:
determining a payment state with the highest priority from the second payment state of the first payment code and the first payment state of the second payment code as a third payment state; and
determining the first interactive action according to the third payment state.

5. The method according to claim 4, wherein the determining the first interactive action according to the third payment state comprises:
determining, in response to the third payment state being the second payment state of the first payment code, the first interactive action according to the third payment state in response to a priority corresponding to the third payment state being higher than or equal to a priority of a payment state corresponding to an interactive action being executed by the client; and
determining, in response to the third payment state being the first payment state of the second payment code, the first interactive action according to the third payment state.

6. The method according to claim 3, further comprising:
displaying, in response toa payment code currently displayed by the client being a payment code in an order cancellation state, a new payment code.

7. The method according to claim 1, further comprising:
stopping, in response to the first payment code being a payment code currently displayed by the client and the second payment state of the first payment code indicating that the first payment code has entered a payment processing flow, a periodical display of new payment codes.

8. The method according to claim 1, wherein the determining, for each payment code recorded by the client, the payment code as a first payment code with a changed payment state when the second payment state of the payment code changes relative to the first payment state, and updating the first payment state corresponding to the first payment code to the second payment state, comprises:
determining whether the payment code meets a first preset condition according to the second payment state of the payment code and the first payment state of the payment code, wherein the first preset condition is that the first payment state and the second payment state indicate that the payment code has entered a payment processing flow and the payment code has not been updated from the payment processing flow to a flow of displaying a payment result page within a first preset duration; and
determining, in response to the payment code not meeting the first preset condition, the payment code as the first payment code with the changed payment state in response to the second payment state of the payment code changing relative to the first payment state, and updating the first payment state corresponding to the first payment code to the second payment state.

9. The method according to claim 8, further comprising:
determining, in response to the payment code meeting the first preset condition, the payment code as a third payment code;
the determining a first interactive action according to the second payment state of the first payment code comprises:
determining the first interactive action according to the second payment state of the first payment code and a fourth payment state of the third payment code, wherein the fourth payment state is a payment state corresponding to the first preset condition, and an interactive action corresponding to the fourth payment state is to display a default result page.

10. The method according to claim 1, further comprising:
deleting the payment code of which first payment state meets a second preset condition from a record of the client, wherein the second preset condition comprises the first payment state of the payment code indicating that the payment code enters a process of displaying a payment result page, or the second preset condition comprises the first payment state of the payment code being an initial state and the payment code remaining in the initial state for a second preset duration.

11. The method according to claim 1, wherein the executing the first interactive action comprises:
in response to the first interactive action being to display a checkout counter, discarding the first interactive action in response to the client displaying the checkout counter, and executing the first interactive action in response to the client not displaying the checkout counter; and
in response to the first interactive action being to display a payment result page, discarding the first interactive action in response to the client displaying the checkout counter, and executing the first interactive action in response to the client not displaying the checkout counter.

12. The method according to claim 11, further comprising:
exiting, in response to a successful payment operation for the checkout counter, display of the payment code, and deleting the payment code recorded by the client; or
exiting, in response to display of the payment result page being ended, display of the payment code, and deleting the payment code recorded by the client.

13. The method according to claim 1, wherein the first interactive action comprises displaying a checkout counter, and the executing the first interactive action comprises:
displaying the checkout counter;
deleting, in response to a payment cancellation operation for the checkout counter, the payment code corresponding to the first interactive action from a record of the client;
selecting a first payment state with a highest priority from the payment codes recorded by the client, and determining a new first interactive action according to the selected first payment state; and
executing the new first interactive action.

14. The method according to claim 13, wherein the deleting, in response to a payment cancellation operation for the checkout counter, the payment code corresponding to the first interactive action from a record of the client, comprises:
deleting, in response to the payment cancellation operation for the checkout counter, the payment code corresponding to the first interactive action from the record of the client, and displaying a new payment code in response to the payment code corresponding to the first interactive action being a payment code currently displayed by the client.

15. The method according to claim 2, wherein the determining, for each payment code recorded by the client, the payment code as a first payment code with a changed payment state when the second payment state of the payment code changes relative to the first payment state, and updating the first payment state corresponding to the first payment code to the second payment state, comprises:
determining whether the payment code meets a first preset condition according to the second payment state of the payment code and the first payment state of the payment code, wherein the first preset condition is that the first payment state and the second payment state indicate that the payment code has entered a payment processing flow and the payment code has not been updated from the payment processing flow to a flow of displaying a payment result page within a first preset duration; and
determining, in response to the payment code not meeting the first preset condition, the payment code as the first payment code with the changed payment state in response to the second payment state of the payment code changing relative to the first payment state, and updating the first payment state corresponding to the first payment code to the second payment state.

16. The method according to claim 15, further comprising:
determining, in a response to the payment code meeting the first preset condition, the payment code as a third payment code;
the determining a first interactive action according to the second payment state of the first payment code comprises:
determining the first interactive action according to the second payment state of the first payment code and a fourth payment state of the third payment code, wherein the fourth payment state is a payment state corresponding to the first preset condition, and an interactive action corresponding to the fourth payment state is to display a default result page.

17. The method according to claim 2, wherein the first interactive action comprises displaying a checkout counter, and the executing the first interactive action comprises:
displaying the checkout counter;
deleting, in response to a payment cancellation operation for the checkout counter, the payment code corresponding to the first interactive action from a record of the client;
selecting a first payment state with a highest priority from the payment codes recorded by the client, and determining a new first interactive action according to the selected first payment state; and
executing the new first interactive action.

18. The method according to claim 17, wherein the deleting, in response to a payment cancellation operation for the checkout counter, the payment code corresponding to the first interactive action from a record of the client, comprises:
deleting, in response to the payment cancellation operation for the checkout counter, the payment code corresponding to the first interactive action from the record of the client, and displaying a new payment code in response to the payment code corresponding to the first interactive action being a payment code currently displayed by the client.

19. A non-transitory computer-readable medium, on which a computer program is stored, wherein the computer program, when executed by a processor, implements a method of code scanning payment, and the method comprises:
recording, when a payment code is generated for a client, a first payment state of the payment code in the client;
obtaining a second payment state of the payment code from a server;
determining, for each payment code recorded by the client, the payment code as a first payment code with a changed payment state when the second payment state of the payment code changes relative to the first payment state, and updating the first payment state corresponding to the first payment code to the second payment state;
determining a first interactive action according to the second payment state of the first payment code; and
executing the first interactive action.

20. An electronic device, comprising:
at least one memory, on which at least one computer program is stored;
at least one processor, configured to execute the at least one computer program on the at least one memory, to implement a method of code scanning payment, wherein the method comprises:
recording, when a payment code is generated for a client, a first payment state of the payment code in the client;
obtaining a second payment state of the payment code from a server;
determining, for each payment code recorded by the client, the payment code as a first payment code with a changed payment state when the second payment state of the payment code changes relative to the first payment state, and updating the first payment state corresponding to the first payment code to the second payment state;
determining a first interactive action according to the second payment state of the first payment code; and
executing the first interactive action.
